(19) United States
(12) Patent Application Publication
(10) Pub. No.: US 2015/0240152 A1
(43) Pub. Date: Aug. 27, 2015

(54) METHOD FOR LABELLING AT LEAST ONE MATERIAL COMPRISING AN ORGANIC OR INORGANIC, SOLID OR LIQUID MATRIX, AND CORRESPONDING MATERIAL

(71) Applicants: CNRS-CENTRE NATIONAL DE LA RECHERCHE SCIENTIFIQUE, Paris Cedex 16 (FR); INSA-INSTITUT NATIONAL DE SCIENCES APPLIQUÉES, Rennes (FR)

(72) Inventors: Guillaume Calvez, Saint-Hilaire-Des-Landes (FR); Francois Le Natur, Rennes (FR); Olivier Guillou, Cesson Sevigne (FR)

(21) Appl. No.: 14/427,412

(22) PCT Filed: Sep. 6, 2013
(86) PCT No.: PCT/EP2013/068435

§ 371 Date: Mar. 11, 2015

(30) Foreign Application Priority Data
Sep. 11, 2012 (FR) 1258525

(51) Int. Cl. C09K 11/06; C09K 11/02; G01N 21/64; C09K 11/77

(52) U.S. Cl. CPC C09K 11/06; C09K 11/7787; C09K 11/7769; C09K 11/025; G01N 21/643; C09K 2211/182; G01N 2021/6439

(57) ABSTRACT

The invention relates to a method for labelling at least one material comprising an organic or inorganic, solid or liquid matrix, comprising at least one step consisting in incorporating therein, during the manufacturing thereof, at least one compound based on at least one luminescent rare earth element according to a concentration which makes this compound detectable under UV irradiation in said material. According to the invention, said compound comprises at least one hexanuclear complex corresponding to formula (I): [Ln⁽¹⁾Ln⁽²⁾Ln⁽³⁾Ln⁽⁴⁾Ln⁽⁵⁾Ln⁽⁶⁾μ₆-O(OH)₈(NO₃)ₙ₁(H₂O)ₙ₂]²⁺ in which: the Ln⁽ⁱ⁾ are identical or different rare earth ions chosen from the group consisting of the ions of Pr, Nd, Sm, Eu, Gd, Tb, Dy, Ho, Er, Tm, Yb, Lu, Y; n₁ is an integer between 0 and 6; and n₂ is an integer between 0 and 14.

### 1. FIELD OF THE INVENTION

The field of the invention is that of the labeling of materials comprising an organic or mineral, solid or liquid matrix. The matrix in question could especially be constituted by a plastic material for manufacturing different objects, a mortar, a mineral phase for encapsulating the medicine, a varnish, a paint or a glue, the list being not exhaustive. More specifically, the invention pertains to a method for labeling such materials enabling them to be identified by optical means.

### 2. PRIOR ART

Materials based on organic or mineral, solid or liquid matrices are abundantly used to manufacture quantities of articles, especially on an industrial scale and it is often desirable to be able to subsequently determine the origin and/or the authenticity of these articles. Such identification proves to be necessary especially to organize the traceability of such articles or again to differentiate possible counterfeiting operations.

Counterfeiting is presently a major problem for many industries, causing them considerable loss of revenue. Numerous economic sectors are affected by this scourge. In addition to the luxury goods and cosmetics industries, traditionally targeted by counterfeiters, this activity is now affecting sectors as varied as those of automobiles, pharmaceuticals and food. This counterfeiting can often raise problems of public health and safety.

Many industries are therefore searching for efficient methods to label the products that they market and/or the packaging used to package these products. This demand is especially high for products made out of polymer, thermoplastic or thermosetting matrices, which are the basic materials in numerous articles and substances.

Many methods for labeling materials are known in the prior art.

The most secure methods implement especially holograms printed on the articles to be labeled or special inks. Certain methods also implement labeling that uses DNA. However, these techniques entail high costs and can therefore only be reserved for products with high added value. For many industrial-scale products manufactured in large quantities, it is however economically unfeasible to use to these techniques.

Other techniques using the optical properties of rare earths have been devised. The patent applications WO-2008034865 and WO-2008148792 describe methods for labeling mineral or organic matrices. In these techniques, photoluminescent, labeling compounds are dispersed in either mineral or organic matrices. These photoluminescent labeling compounds comprise at least one photoluminescent rare earth bound to an organic ligand. However, these documents describe only labels or markers constituted by structures in which the metal sites are mononuclear. Within these markers, different rare earths can be introduced. Examples of markers comprising 2, 3, 4 or 13 different rare-earth ions are briefly cited but none of them presents any polynuclear metal site. There are in fact only very few rare-earth-based polynuclear compounds. In addition, all the existing compounds are poorly soluble and extremely unstable, especially in the presence of moisture. Besides, most of these compounds are synthesized from very dangerous compounds such as rare-earth perchlorates and are therefore not compatible with the demands of “green chemistry” which are becoming increasingly dominant in the industrial world. The synthesis yield is also very low and therefore economically unpromising. For all these reasons, photoluminescent markers or labels based on rare-earth polynuclear entities are unusable on an industrial scale.

### 3. GOALS OF THE INVENTION

The invention is aimed especially at overcoming these drawbacks of the prior art.

The object of the present invention, in at least one embodiment, to provide a method for labeling materials based on organic or mineral, solid or liquid matrices with a view to their subsequent authentication if necessary.

It is another goal of the present invention, in at least one embodiment, to propose a method of this kind that is simple and costs little to implement.

It is yet another goal of the invention to propose a method such as this that implements labeling compounds, the insertion of which into the host matrix does not modify the properties of this host matrix.

It is thus a goal of the present invention, in at least one embodiment, to propose a method such as this implementing labeling compounds, which, chemically, are sufficiently inert relative to the matrix so that their introduction into this matrix does not raise any problem of compatibility with it.

It is another goal of the invention, in at least one embodiment, to describe a labeling method of this kind that can be easily and rapidly adaptable, i.e. a method that is capable of implementing a very large number of labeling compounds that are structurally very close but have easily differentiable optical signatures so as to permit a differentiated labeling of the articles and products made with said materials based on liquid or solid, mineral or organic matrices that constitute them, as a function for example of the manufactured batch, the date of manufacture, the client or the application in view.

It is yet another goal of the invention, in at least one embodiment, to disclose a method of this kind that implements compounds visible to the naked eye once inserted into the matrix.

It is yet another goal of the invention, in at least one embodiment, to disclose a method of this kind that is compatible with the demands of “green chemistry”.

### 4. SUMMARY OF THE INVENTION

These goals, as well as others that shall appear here below, are achieved by means of a method for labeling at least one material comprising an organic or mineral, solid or liquid matrix comprising at least one step for the incorporation therein, during its manufacture, of at least one compound based on at least one luminescent rare earth in a concentration that makes this compound detectable under UV irradiation in said material.

According to the invention, said material is characterized in that said compound comprises at least one hexa-nuclear complex meeting the formula (I):

[Ln⁽¹⁾Ln⁽²⁾Ln⁽³⁾Ln⁽⁴⁾Ln⁽⁵⁾Ln⁽⁶⁾μ₆-O(OH)₈(NO₃)ₙ₁(H₂O)ₙ₂]²⁺ (I)

wherein:

the Ln⁽ⁱ⁾ represent identical or different rare-earth ions chosen from the group constituted by the ions of Pr, Nd, Sm, Eu, Gd, Tb, Dy, Ho, Er, Tm, Yb, Lu, Y

n₁ is an integer ranging from 0 to 6;

n₂ is an integer ranging from 0 to 14.

According to such a method, the labeling compounds are constituted by complexes comprising six identical or different rare-earth ions, at least one of which is photoluminescent, said complexes being simply mixed with the solid or liquid, organic or mineral matrix on which the material to be labeled is based. Such a mixture does not involve any chemical, ionic or covalent, interaction with the matrix itself and does not lead to any modification of the spectrophotometric characteristics of said labeling compounds and to no significant modification of the physical/chemical properties of the matrix. Such labeling compounds are also sufficiently inert chemically so that their introduction into the matrix does not raise any problem of compatibility with other compounds present in the materials based on organic matrices, such as especially coloring agents and more generally any type of additive. Thus, the physical/chemical properties of the material are not affected by such labeling and the industrial process for manufacturing the products to be labeled is not thereby modified.

Also according to the invention, the hexa-nuclear complexes based on one or more different rare earths make it possible to compose a multitude of photoluminescent signatures (for an excitation at a given wavelength), these complexes furthermore possessing the same chemical properties. The labeling compounds constituted by one or more hexa-nuclear complexes that can be used in the context of the present invention are therefore very numerous and can therefore be regularly or randomly changed, thereby making it almost impossible for counterfeiters to copy the labeled materials. In addition, the integration of different rare-earth ions into the labeling compounds through the use of at least two homo-nuclear complexes or of at least one hetero-nuclear complex greatly broadens the range of signatures possible as compared with the markers according to the patent application WO-2008034865 and WO-2008148792. The great number of possible combinations of markers or labels according to the invention and therefore of a corresponding optical signatures also makes it more complicated for third parties to counterfeiting of the signature. This makes the labeling and the authentication of the products labeled by the method according to the invention all the more reliable.

The hexa-nuclear complexes according to the invention are sufficiently photoluminescent under UV rays for use in very low concentrations in order to be detected by spectrophotometry. These compounds are therefore easy to show up in routine controls since they are photoluminescent under UV irradiation. They have the advantage of being invisible in the absence of UV radiation, once included in the material and then require the use of a device such as an UV lamp to be detected. For certain of them, these complexes are sufficiently photoluminescent under UV irradiation to be capable of being detected if necessary by the naked eye. The fact of being able to detect a photoluminescence under UV by the naked eye considerably limits the cost of identifying products labeled according to the method of the invention. The use of such labels in very small quantities thus makes it possible to not modify the properties, especially the rheological, mechanical or thermal properties of the material thus labeled.

The electronic transitions for rare earths are situated between discrete levels and this is reflected in absorptions and emissions of highly monochromatic light.

In the field of the invention, certain trivalent rare earths make it possible to obtain very special colors put to advantageous use in the glass and ceramics industry where rare earths are used in the composition of pigments.

At the level of the emission, applications have been developed, in relation with industrial availability of rare earths with sufficient levels of purity: color television, fluorescent lighting and medical radiography especially. A great variety of emissions can be obtained according to the nature of the rare earth implemented and the respective positions of the excited or fundamental energy levels. Depending on the rare-earth element chosen, the light emission is localized in the near ultra-violet as in the case of cerium, the visible range, (red for europium, orange for samarium, green for terbium, yellow for dysprosium, blue for thulium), or the near infra-red as in the case of neodymium, holmium, ytterbium or erbium.

It is to be specified that the term “homo-hexa-nuclear complex” is understood to mean a complex comprising, within the same molecule, six ions of the same rare earth. In the same way, the term “hetero-hexa-nuclear complex” is understood to mean a complex comprising, within the same molecule, six ions of at least two different rare earths.

According to the invention, the method for labeling a solid or liquid, mineral or organic matrix can be carried out as follows:
by the mixing with the matrix of at least two homo-hexa-nuclear complexes, each comprising a different luminescent rare earth; and/or
by mixing with the matrix of at least one hetero-hexa-nuclear complex, therefore comprising two to six different luminescent rare earths.

Indeed, the distance between the ions varies according to whether ions belong to one and the same complex or to different complexes. Quite logically, the ions belonging to the same complex are more proximate than those belonging to different complexes. Since the interactions between the ions depend on the distance between the nuclei, the emission spectrum produced by two ions belonging to the same complex is different from that emitted by these same ions when they each belong to different complexes. This parameter limits the possibilities of counterfeiting by a third party wishing to reproduce the photoluminescent complex to imitate products labeled by the method according to the invention.

The phenomenon designated by the term “lanthanide contraction” considerably influences the method of synthesis of complexes and their stability. Therefore, the method of manufacture of these hexa-nuclear compounds based on luminescent rare earth is particularly difficult and requires great expertise.

In the following description, the ions are considered to be proximate when the distance between them is smaller than or equal to 6 angströms (Å).

In a preferred embodiment, said compound comprises at least two homo-hexa-nuclear complexes, each of said complexes meeting the formula (I) in which the Ln⁽ⁱ⁾ are identical, the Ln⁽ⁱ⁾ of one complex being different from the Ln⁽ⁱ⁾ of another complex. This particular embodiment makes it possible to design a label whose optical signature is different from that of a hetero-hexa-nuclear complex based on the same rare earths. This phenomenon can be explained by the fact that the distance between two ions is different depending on whether they belong to the same complex or to different complexes. Thus, although the label is formulated in the form of a single crystalline phase, the counterfeiting of the labeling according to the invention is made more difficult through the influence of the distance between rare-earth ions on the emission spectrum.

In another preferred embodiment, said compound comprises at least one hetero-hexa-nuclear complex meeting the formula (I) in which the Ln(i) are different. This embodiment has the advantage of being able to form a multitude of different optical signatures, by combining the rare-earth ions in different ways. It is indeed possible to compose, according to specific requirements, different photoluminescent hexa-nuclear complexes by combining two to six different rare earths, among all the rare-earth ions available, within the same hexa-nuclear complex. Just as in the case of the hexa-nuclear complexes, the emission spectrum also depends on the distance between the ions. This particular feature becomes all the more interesting when the labeling of the materials implements different hexa-nuclear labels. This makes it possible not only to broaden the range of optical signatures available to authenticate a product but also to reinforce the unique and hard-to-reproduce character of each label.

Advantageously, said at least one complex of formula (I) is solvated by a solvent chosen in the group constituted by the polyols and the polyethers. The inventors have indeed discovered that the rare-earth-based hexa-nuclear complexes dissolve particularly well and are stable in the long term in polyols and polyethers. In addition, these are low-cost compounds and their handling holds little danger for an operator. They are therefore particularly appropriate for the labeling of products manufactured on a large scale.

Preferably, said solvent is glycol ethylene. The inventors have indeed discovered that the rare-earth-based hexa-nuclear complexes are particularly stable and soluble in glycol ethylene. In addition, this solvent has low pollutant capacity and costs little to produce. It is also easily available. This characteristic contributes to making the method of the invention more economical, less dangerous to handle and less pollutant as compared with the prior-art techniques. Finally, glycol ethylene reacts little and can easily be incorporated into different types of solid or liquid, organic or mineral matrices.

In one preferred embodiment, the Ln⁽ⁱ⁾ are chosen from the group constituted by Eu, Tb, Y, Dy, Ho, Er, Gd.

Advantageously, said compound comprises complexes meeting the formula (I) bound by organic ligands of the unsaturated carboxylate type. These unsaturated ligands are particular advantageous because they amplify the phenomenon of photoluminescence of ions proximate to one another through the presence of double bonds. The ligands then act as antennas.

Preferably, said organic ligands are chosen from the group constituted by the phtalate, isophtalate, terephtalate, trimesate, trimellitate, pyromellitate, mellitate ions.

Advantageously, said concentration of the labeling compound in the matrix is from 1 gram per ton to 50 grams per ton of matrix. The method according to the invention therefore enables the labeling of large quantities of materials in using only very small quantities of labels. Thus, the labeling method according to the invention is particularly economical. In addition, it is not necessary to modify the production line for the liquid or organic, mineral or solid matrix, enabling the manufacture of the products. Besides, the small quantity of labels to be implemented limits the wastage of reagents and the pollution caused by the use of these labels. The method of the invention is therefore simple to implement and compatible with the requirements of green chemistry sought by most industrialists, institutions and consumers.

In one advantageous embodiment, said compound based on at least one luminescent rare earth is incorporated into said matrix by successive dilutions. The marking method according to the invention is therefore particularly simple to implement since it requires no special knowhow and no specific equipment for its implementation.

An object of the invention is also a material based on an organic or mineral, solid or liquid matrix, characterized in that it integrates at least one luminescent tracer constituted by a compound based on at least one luminescent rare earth ion in a concentration making this compound detectable by UV irradiation, said compound comprising at least one hexa-nuclear complex meeting the formula (I):

[Ln⁽¹⁾Ln⁽²⁾Ln⁽³⁾Ln⁽⁴⁾Ln⁽⁵⁾Ln⁽⁶⁾μ₆-O(OH)₈(NO₃)ₙ₁(H₂O)ₙ₂]²⁺ (I)

wherein:

the Ln⁽ⁱ⁾ represent identical or different rare-earth ions chosen from the group constituted by the ions Pr, Nd, Sm, Eu, Gd, Tb, Dy, Ho, Er, Tm, Yb, Lu, Y

n₁ is an integer ranging from 0 to 6,

n₂ is an integer ranging from 0 to 14.

The rare-earth-based photoluminescent hexa-nuclear labeling compounds therefore constitute tracers used to label any material based on a solid or liquid, organic or mineral matrix. They therefore enable the subsequent authentication of said material even after a fairly long period of use. In addition, the very great number of possible combinations makes it possible to design unique optical signatures specific to a product or to a company. Since the emission spectrum and therefore the optical signature depend on the distance between the ions present, it is impossible for a third party to determine the number and nature of the chemical species contained in the complex and therefore to reproduce the signature of a product with the aim of counterfeiting it. The authentication of the product labeled by the method according to the invention is therefore all the more reliable.

Advantageously, said at least one complex with the formula (I) is solvated by a solvent chosen in the group constituted by the polyols and the polyethers. Hitherto, the rare-earth hexa-nuclear photoluminescent complexes were difficult to use in liquid matrices because of their poor stability in wet surroundings and their low solvability. The inventors have indeed discovered that hexa-nuclear complexes based on rare and photoluminescent earths are particularly soluble and stable in polyols and polyethers. In addition, these solvents cost little, are easily available and present little danger. They are therefore particularly suited to industrial-scale exploitation.

According to one variant, the compound labeling the material comprises complexes meeting the formula (I) bound by organic ligands of the unsaturated carboxylate type, said ligands being preferably chosen from the group constituted by the phthalate, isophthalate, terephthalate, trimesate, trimellitate, pyromellitate, mellitate ions.

Advantageously, the concentration of the labeling compound in the materials is from 1 gram per ton to 50 grams per ton of matrix.

### 5. LIST OF FIGURES

Other features and advantages of the invention shall appear from the following description of a preferred embodiment, given by way of a simple, illustrative and non-exhaustive example, and from the appended drawings, of which:

FIG. 1 presents the structures of different compositions based on hexa-nuclear complexes, incorporating photoluminescent rare earths according to the invention;

FIG. 2 is a graph presenting the results of spectrometric analyses of each composition shown in FIG. 1.

### 6. DESCRIPTION OF ONE EMBODIMENT OF THE INVENTION

The general principle of the invention is based on the labeling of materials comprising a solid or liquid, organic or mineral matrix by rare-earth-based hexa-nuclear compounds. Rare earths possess excellent chemical and optical properties, making them very promising for the designing of materials in medical imaging. In the present invention, their unique optical properties are exploited to design made-to-order photoluminescent labels, i.e. labels that can serve as optical signatures especially to authenticate a product and very simply detect counterfeit if any, or again to ensure its traceability. In other words, the invention entails the designing of rate-earth-based hexa-nuclear complexes which, when exposed to UV radiation, have an emission spectrum that is proper to them. Through the very large number of available combinations, it is possible to design a great number of optical signatures, all unique, enabling the authentication with certitude of the products manufactured with materials into which the photoluminescent compound is incorporated.

6.1) Manufacture of a Hexa-Nuclear Complex Based on Rare-Earth Ions

10 mL of a solution, final concentration 1 mol·L⁻¹, of a mixture of rare-earth nitrates in 9 volumes of ethanol and 1 volume of water is prepared. To this solution of rare-earth ions, an aqueous solution of sodium hydroxide, 0.5 mol·L⁻¹, is added drop by drop with vigorous stirring. It is very important to control the addition of the sodium hydroxide solution to the solution of rare-earth ions. Preferably, one drop of sodium hydroxide is added about every 30 seconds. The precipitate thus formed is recovered, rinsed with ethanol, filtered and then dried in air. The dry precipitate is then analyzed by microanalysis by EDS and by X-ray diffraction on powder. The filtrate for its part is recycled by a precipitation of the rare-earth hydroxides. For example, a yield of 23% is obtained for the synthesis of a hexa-nuclear complex based on Dy³⁺ and Er³⁺, for which 50 drops of sodium hydroxide solution are added.

Table 1 here below summarizes various examples of compositions of the initial mixture of rare-earth ions for the synthesis of hexa-nuclear complexes.

TABLE 1
Example of photoluminescent hexa-nuclear compounds incorporating
rare earths

| Qualitative | | | | | |
|---|---|---|---|---|---|
| composition of the | Relative proportion of each ion in | | | | |
| mixture of rare- | the mixture of rare-earth | | | | |
| earth ions | ions expressed in molar % | | | | |
| Y—Tb—Eu | 50/25/25 | | | | |
| Y—Tb | 10/90 | 20/80 | 50/50 | 80/20 | 90/10 |
| Eu—Tb | 10/90 | 20/80 | 50/50 | 80/20 | 90/10 |
| Gd—Tb | 10/90 | 20/80 | 50/50 | 80/20 | 90/10 |
| Tb—Dy | 10/90 | 20/80 | 50/50 | 80/20 | 90/10 |
| Dy—Ho | 10/90 | 20/80 | 50/50 | 80/20 | 90/10 |
| Ho—Er | 10/90 | 20/80 | 50/50 | 80/20 | 90/10 |
| Er—Tm | 10/90 | 20/80 | 50/50 | 80/20 | 90/10 |
| Tm—Yb | 10/90 | 20/80 | 50/50 | 80/20 | 90/10 |
| Ho—Yb | 10/90 | 20/80 | 50/50 | 80/20 | 90/10 |

The synthesis of hexa-nuclear complexes according to the invention therefore costs little. Besides, the reagents used to produce these hexa-nuclear complexes present little danger in their handling. The recycling of the filtrate also limits losses. The synthesis reaction of the hexa-nuclear complexes is done in an aqueous medium. Finally, all these technical features are compatible with the principles of green chemistry, namely they entail a recycling of wastes and the use of low-pollutant and low-danger reagents.

6.2) Solvation of a Hexa-Nuclear Complex

The main problem with the solvation of hexa-nuclear complexes comes from their high sensitivity to moisture. Indeed, hexa-nuclear compounds are classically obtained by hydrolysis according to the following reaction:

qLn(H₂O)ₙ³⁺<->Ln_{q}(OH)ₚ^{3q-p}+pH⁺ with Kqp=[Ln_{q}(OH)ₚ^{3q-p}][H⁺]ₚ/[Ln³⁺]_{q}

The hydration rate, equal to the number of OH⁻/number of Ln³⁺, is about 1.67. In the presence of moisture, the hydrolysis of the hexa-nuclear compounds is therefore continued and to lead to the corresponding hydroxide (hydration rate of 3). In fact, this high sensitivity to humidity dictates numerous constraints in the handling of these compounds. Besides, it makes them impossible to use in a solution.

The inventors have discovered that rare-earth hexa-nuclear complexes are highly soluble in glycol ethylene and more generally in polyols. Similar results have been demonstrated with glycerol, which is a solvent less toxic than glycol ethylene. The method of synthesis, as described in point 6.1, followed by a solubilizing in glycol ethylene therefore protects hexa-nuclear compounds against moisture and makes it possible to use them as reagents in solution. For example, a hexa-nuclear complex based on Eu³⁺ can be preserved, diluted volume for volume, for at least 24 h in a mixture of ethylene glycol/ethanol, whereas in the solid state, this same compound gets very speedily degraded. Diluted in 10 volumes of ethanol, this same compound can be kept for at least 24 h and can then be used to react with other species.

6.3) Example of Preparation of a Compound of Hexa-Nuclear Complexes of Europium Bound by Terephtalate Ligands by Direct Synthesis.

A hexa-nuclear complex based on europium is prepared according to the method described under the point 6.1. The complex thus obtained is then dissolved in glycol ethylene in order to obtain a solution of saturated glycol ethylene. To 15 mL of this solution of glycol ethylene, saturated in hydrated europium hexa-nuclear complex, 10 mL of a solution of terephtalic acid dissolved in DMF in a concentration of 0.03 mol·L⁻¹ is added slowly. The entire mixture is then heated to 120° C. over night, thus enabling the precipitation of a final compound based on hexa-nuclear complexes. Once the solution is cooled, the precipitate is recovered, rinsed in acetonitrile and then dried. The dry precipitate is then structurally characterized by X-ray diffraction on powder. The crystallographic data corresponding to this compound are: triclinical system, space group P−1(no 2) with a=10.49 Å, b=11.53 Å, c=12.36 Å, α=86.87°, β=114.27° and γ=71.62°.

6.4) Comparison of Several Labeling Compounds According to the Invention

According to the method described under point 6.3, different labeling compounds based on rare-earth hexa-nuclear complexes according to the invention are prepared, namely:
a mixture (1) constituted by a first compound obtained by the reaction of homo-hexa-nuclear complexes of Tb³⁺ bound by a terephtalate ligand and a second compound obtained by the reaction of hexa-nuclear complexes of Eu³⁺ with the same terephtalate ligand, said mixture being constituted by a 50% mole fraction of the first compound and a 50% mole fraction of the second compound;
a compound (2) obtained by the reaction of hetero-hexa-nuclear complexes based on Eu³⁺ and of Tb³⁺ in equivalent mole proportions (50/50) with the same terephtalate ligand;
a compound (3) obtained by the reaction of homonuclear complexes of Tb³⁺ and 50% of homonuclear complexes of Eu³⁺ with the same terephtalate ligand.

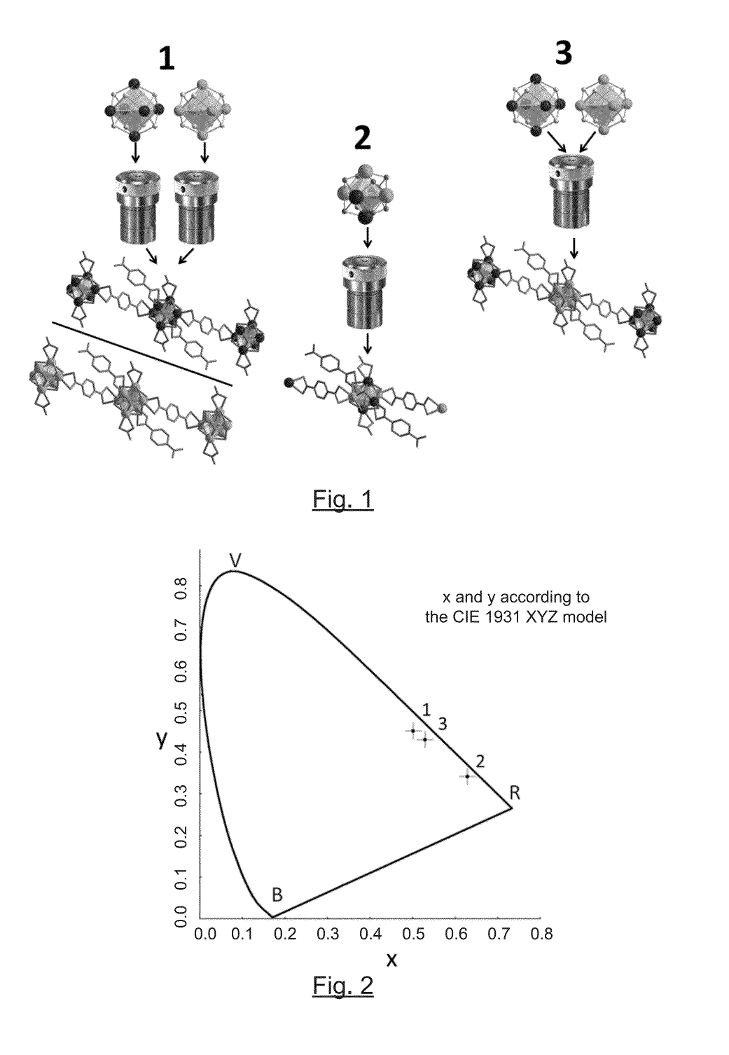

These mixtures and compounds, depicted schematically in FIG. 1, therefore have identical chemical compositions.

This mixture and these compounds are then each exposed to UV irradiation and the emission spectrum of each of these preparations is then measured by spectrophotometry. The excitation was done under irradiation at 312 nm. The colorimetrical coordinates x and y (CIE 1931) are entered in FIG. 2.

As indicated in FIG. 2, it is noted that although each of these mixtures and compounds have the same chemical composition, the emission spectra are radically different. These differences come from the fact that the distances between different ions are reduced in a hetero-hexa-nuclear compound (distances between different ions less than 5 Å) as compared with the mixture of homo-hexa-nuclear compounds (distances between different ions greater than, 100 Å) and a compound based on a mixture of homo-hexa-nuclear complexes (distance between different ions approximately equal to 10 Å). Consequently, the interactions between the ions are different and each of these preparations has different properties of luminescence. More specifically, the color emitted by the compound (1) comes from the addition of the colors emitted by each of the compounds based on homo-nuclear complexes. In other words, the color of the mixture results from the addition of the color emitted by the on Tb³⁺-based homo-nuclear complex and that of the Eu³⁺-based homo-nuclear complex.

The color produced by the compound (2) is different from that of the compound (1) because of the transfer of energy between the ions Tb³⁺ and Eu³⁺.

In the same way, the color obtained by the compound (3) is again different from that produced by each of the preparations (1) and (2). Indeed, although each of the complexes has only one type of ion, these complexes interact and produce a different color from that emitted by the corresponding mixture (1). This difference of emission is due to the transfer of energy between Eu³⁺ ions and Tb³⁺ ions belonging to different complexes. This transfer of energy is different from that observed for the compound (2) because the distance between ions Tb³⁺ and Eu³⁺ is greater.

The color emitted by each composition depends on the number of linked ions in the same complex, the diversity of the chemical elements brought together in the same complex, their relative proportion within the same complex and the number of hexa-nuclear complexes brought together in the composition. Thus, although the complexes have identical chemical properties and crystalline structures, there is too great a number of possible combinations of these different parameters for a third party to be able to reproduce the photoluminescent labeling material without information. This special feature is therefore highly valuable when it is desired to produce unique identification labels in order to authenticate products. In addition, the inventors having found a means to stabilize the hexa-nuclear complexes in wet surroundings, it is henceforth possible to label liquid matrices.

1. Method for labeling at least one material comprising an organic or mineral, solid or liquid matrix comprising at least one step for the incorporation therein, during its manufacture, of at least one compound based on at least one luminescent rare earth in a concentration that makes this compound detectable under UV irradiation in said material, characterized in that said compound comprises at least one hexa-nuclear complex meeting the formula (I):
[Ln⁽¹⁾Ln⁽²⁾Ln⁽³⁾Ln⁽⁴⁾Ln⁽⁵⁾Ln⁽⁶⁾μ₆-O(OH)₈(NO₃)ₙ₁(H₂O)ₙ₂]²⁺ (I)
wherein:
the Ln⁽ⁱ⁾ represent identical or different rare-earth ions chosen from the group constituted by the ions of Pr, Nd, Sm, Eu, Gd, Tb, Dy, Ho, Er, Tm, Yb, Lu, Y:
n₁ is an integer ranging from 0 to 6;
n₂ is an integer ranging from 0 to 14.

2. Method according to claim 1 wherein said at least one complex of formula (I) is solvated by a solvent chosen in the group constituted by the polyols and the polyethers

3. Method according to claim 1 characterized in that said compound comprises at least two homo-hexa-nuclear complexes, each of said complexes meeting the formula (I) in which the Ln⁽ⁱ⁾ are identical, the Ln⁽ⁱ⁾ of one complex being different from the Ln⁽ⁱ⁾ of another complex.

4. Method according to claim 1 characterized in that said compound comprises at least one hetero-hexa-nuclear complex meeting the formula (I) in which the Ln(i) are different.

5. Method according to claim 2 characterized in that said solvent is glycol ethylene.

6. Method according to claim 1 characterized in that the Ln⁽ⁱ⁾ are chosen from the group constituted by Eu, Tb, Y, Dy, Ho, Er, Gd.

7. Method according to claim 2 characterized in that said compound comprises complexes meeting formula (I) bound by organic ligands of the unsaturated carboxylate type.

8. Method according to claim 7 characterized in that said ligand is chosen from the group constituted by the phtalate, isophtalate, terephtalate, trimesate, trimellitate, pyromellitate, mellitate ions.

9. Method according to claim 1 characterized in that said concentration of the labeling compound in the matrix is from 1 gram per ton to 50 grams per ton of matrix.

10. Method according to claim 1 characterized in that said compound based on at least one luminescent rare earth is incorporated into said matrix by successive dilutions.

11. Material based on an organic or mineral, solid or liquid matrix, characterized in that it integrates at least one luminescent tracer constituted by a compound based on at least one luminescent rare earth ion in a concentration making this compound detectable by UV irradiation, said compound comprising at least one hexa-nuclear complex meeting the formula (I):
[Ln⁽¹⁾Ln⁽²⁾Ln⁽³⁾Ln⁽⁴⁾Ln⁽⁵⁾Ln⁽⁶⁾μ₆-O(OH)₈(NO₃)ₙ₁(H₂O)ₙ₂]²⁺ (I)
wherein:
the Ln⁽ⁱ⁾ represent identical or different rare-earth ions chosen from the group constituted by the ions Pr, Nd, Sm, Eu, Gd, Tb, Dy, Ho, Er, Tm, Yb, Lu, Y
n₁ is an integer ranging from 0 to 6,
n₂ is an integer ranging from 0 to 14.

12. Material according to claim 11 characterized in that said at least one complex with the formula (I) is solvated by a solvent chosen in the group constituted by the polyols and the polyethers.

13. Material according to claim 11 characterized in that said compound comprises complexes meeting the formula (I) bound by organic ligands of the unsaturated carboxylate type.

14. Material according to claim 11 characterized in that said ligand is chosen from the group constituted by the phthalate, isophthalate, terephthalate, trimesate, trimellitate, pyromellitate, mellitate ions.

15. Material according to claim 11 characterized in that said concentration ranges from 1 gram per ton to 50 grams per ton of matrix.
